(19) United States
(12) Patent Application Publication
(10) Pub. No.: US 2026/0295307 A1
(43) Pub. Date: Oct. 1, 2026

(54) Lung Demand Regulator

(71) Applicant: Dräger Safety AG & Co. KGaA, Lubeck (DE)

(72) Inventors: Paul James Ringer, Consett (GB); Robert Miller, Whitley Bay (GB); Iain Brechtelsbauer, Whitley Bay (GB)

(21) Appl. No.: 19/569,162

(22) Filed: Mar. 17, 2026

(30) Foreign Application Priority Data
Mar. 27, 2025 (EP) 25166614.5

(51) Int. Cl. A62B 7/04; A62B 9/02

(52) U.S. Cl. CPC A62B 7/04; A62B 9/022

(57) ABSTRACT

A valve assembly for a lung demand regulator of a breathing apparatus may include a regulator valve apparatus being actuatable between a closed position in which no flow is permitted and an open position in which flow is permitted; a lockout mechanism configurable in: a lockout configuration, and a release configuration; wherein the lockout mechanism comprises a spring plunger having a moveable element configured to axially extend from a body of the spring plunger in the lockout configuration and in the release configuration, so as to retain the lockout mechanism in either of the lockout configuration and the release configuration, and wherein the moveable element is configured to be depressed by a portion of the lockout mechanism during movement of the lockout mechanism, resisting movement of the lockout mechanism between the release and lockout configurations. Also disclosed is a lung demand regulator and a breathing apparatus.

### CROSS-REFERENCE TO RELATED APPLICATIONS

[000.5] This application claims the priority of European Patent Application No. 25166614.5 filed on Mar. 27, 2025, and titled “Lung Demand Regulator”, which is hereby incorporated by reference in its entirety for all nonlimiting purposes.

### TECHNICAL FIELD

This disclosure relates to lung demand regulators for breathing apparatus and, more specifically, to lung demand regulators for self-contained breathing apparatus.

### BACKGROUND

Breathing apparatus commonly comprises a lung demand regulator, which may also be known as a second-stage regulator. The lung demand regulator is configured to deliver breathing gas to the user at a suitable pressure for breathing. In order to conserve breathing gas, the user may need to disable the breathing gas flow when not required, such as when removing the mask. A lockout mechanism may be provided for disabling breathing gas flow. Lockout mechanisms should be reliable and simple to activate.

Therefore, it should be understood that it is desirable to provide improvements to demand regulators in relation to lockout mechanisms.

### SUMMARY

According to a first example aspect, there is provided a valve assembly comprising a lockout mechanism comprising a spring plunger.

The spring plunger may comprise a moveable element. The moveable element of the spring plunger may be configured to axially extend from a body of the spring plunger in a lockout configuration and in a release configuration of the lockout mechanism, so as to retain the lockout mechanism in either of the lockout configuration and the release configuration.

The moveable element of the spring plunger may be configured to be depressed by a portion of the lockout mechanism during movement of the lockout mechanism between release and lockout configurations of the lockout mechanism, so as to resist movement of the lockout mechanism between the release and lockout configurations.

According to another aspect, there is provided a valve assembly for a lung demand regulator of a breathing apparatus comprising: a regulator valve apparatus for regulating a flow of breathing gas, the regulator valve apparatus being actuatable between a closed position in which no flow is permitted and an open position in which flow is permitted; a lockout mechanism configurable in: i) a lockout configuration in which the regulator valve apparatus is secured in the closed position, and ii) a release configuration in which the regulator valve apparatus is freely moveable; wherein the lockout mechanism comprises a spring plunger; wherein a moveable element of the spring plunger is configured to axially extend from a body of the spring plunger in the lockout configuration and in the release configuration, so as to retain the lockout mechanism in either of the lockout configuration and the release configuration, and wherein the moveable element of the spring plunger is configured to be depressed by a portion of the lockout mechanism during movement of the lockout mechanism between the release and lockout configurations, so as to resist movement of the lockout mechanism between the release and lockout configurations.

The regulator valve apparatus may comprise one or more of a metering or regulating valve, a moveable or deformable diaphragm, and a linkage configured to transmit movement of the diaphragm to actuate the valve.

The valve regulator apparatus, and optionally the diaphragm and linkage, may be configured to apply sufficient force to the lockout mechanism to move the lockout mechanism from the lockout configuration to the release configuration on application of a first-breath pressure differential to the valve regulator apparatus, optionally to the diaphragm.

The body of the spring plunger may be fixed within the valve assembly.

The moveable element may be biased to at least partially extend from an opening in the body of the spring plunger by a biasing element. The biasing element may be a helical spring or a volume of compressed gas.

The moveable element may be retained within the body of the spring plunger. The opening of the spring plunger may be on an end, optionally an axial end, of the spring plunger.

The lockout mechanism may comprise a pivotable lever in operative connection with the spring plunger such that angular movement of the pivotable lever depresses the spring plunger.

The pivotable lever may be configured in a first angular position in the lockout configuration and configured in a second angular position in the release configuration. The pivotable lever may be configured to pivot between the first angular position and the second angular position.

The pivotable lever may be pivotable about a pivot axis, the pivot axis being perpendicular to an axial direction of movement of the moveable element of the spring plunger. The pivot axis and the axial direction may be intersecting.

The pivotable lever may be constrained to move between the first and second angular positions, which may represent rotational limits of the pivotable lever. The lockout mechanism may comprise one or more end stops which constrain rotation of the pivotable lever.

The pivotable lever may comprise a first lever arm configured to operatively connect with the spring plunger, and a second lever arm configured to engage the regulator valve apparatus in the lockout configuration.

The first and second lever arms may extend from the pivot axis in different directions. The first and second lever arms may be non-parallel. The first lever arm may be shorter than the second lever arm.

The first lever arm may comprise a distal tip configured to engage the moveable element of the spring plunger.

The distal tip may be formed such that friction between the distal tip and the moveable element is minimised.

A coefficient of friction between the narrowed distal tip of the first lever arm and the moveable element of the spring plunger may be sufficiently low as to permit the distal tip to slide over the moveable element.

The moveable element of the spring plunger may comprise a convex surface such that a lateral force applied to the moveable element by the lockout mechanism causes the moveable element to depress into the body of the spring plunger.

The lockout mechanism may be configured to be moved from the release configuration to the lockout configuration by application of force on an activation component of the lockout mechanism by a user. The activation component may be a lever or button which is pressable by a user.

The lever or button may be accessible externally accessible to a user when the valve assembly is incorporated into a lung demand regulator.

The spring plunger may be a ball plunger, a pin plunger, a hydraulic plunger, or a pneumatic plunger.

A force required to depress the moveable element such that lockout mechanism can move between the lockout configuration and the release configuration may be at least 5 N. The force may be between 5 N and 10 N. The force may be between 6 N and 9.4 N. The force may vary as the lockout mechanism is actuated.

According to a example second aspect, there is provided a lung demand regulator comprising a valve assembly according to the first aspect.

The lockout mechanism may be configured to be moved from the lockout configuration to the release configuration by a diaphragm of the lung demand regulator pushing against the lockout mechanism when a pressure differential across a first side and a second side of the diaphragm exceeds a threshold.

According to a third example aspect, there is provided a breathing apparatus comprising a lung demand regulator according to the second aspect. The breathing apparatus may further comprise a face mask for connection to the lung demand regulator.

### BRIEF DESCRIPTION OF THE DRAWINGS

Arrangements of the invention will now be described, by way of example, and with reference to the accompanying drawings, in which:

FIG. 1 schematically shows a breathing apparatus according to an example arrangement comprising a breathing mask and a lung demand regulator;

FIG. 2 schematically shows a breathing mask according to an example arrangement comprising a demand regulator;

FIG. 3 schematically shows a cross-sectional view of a lung demand regulator according to an example arrangement. The plane of the cross-sectional view shown in FIG. 3 is illustrated in FIG. 2.

FIG. 4 schematically shows a cross-sectional view of a valve assembly of lung demand regulator of FIG. 3 in a release configuration according to an example arrangement. The plane of the cross-sectional view shown in FIG. 4 is the same as that in FIG. 3.

FIG. 5 schematically shows a cross-sectional view of the valve assembly of FIG. 4 in lockout configuration according to an example arrangement. The plane of the cross-sectional view shown in FIG. 5 is the same as that in FIG. 3.

FIGS. 6A, 6B, and 6C schematically show cross sectional views of a spring plunger of the lung demand regulator in the release configuration, an intermediate configuration during movement between the release and lockout configurations, and the lockout configuration

### DETAILED DESCRIPTION OF THE DRAWINGS

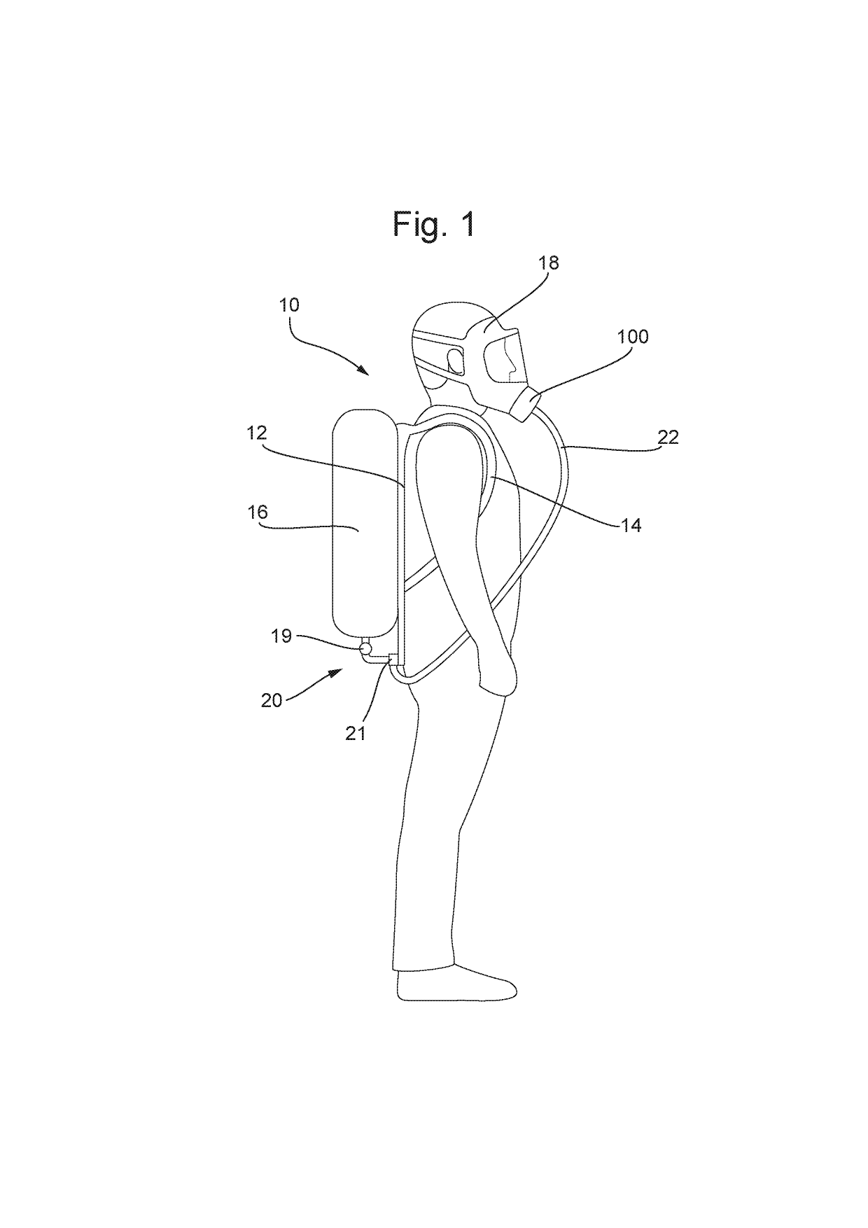

With reference to FIG. 1, an example breathing apparatus 10 is shown. The breathing apparatus 10 is a self-contained breathing apparatus (SCBA) and comprises a support frame or backplate 12, straps 14 for securing the SCBA to a user, a breathing gas cylinder 16, a face mask 18, a lung demand regulator 100 connectable to the face mask 18, and a pneumatics system 20 for delivering breathing gas from the cylinder 16 via a flexible conduit or hose 22 to the lung demand regulator 100, to thereby deliver breathing gas to the user wearing the face mask 18 on demand. The pneumatics system 20 is connected to the cylinder 16 via a valve 19. The breathing apparatus 10 may further comprise other components or systems which are not shown, including but not limited to an electrical system, a monitoring system, or a communications system. The lung demand regulator 100 is referred to as the regulator 100 throughout.

In this illustrated arrangement, the breathing apparatus is a self-contained breathing apparatus (SCBA), but it should be understood that the lung demand regulator may also have applications in other types of breathing apparatus, such as self-contained underwater breathing apparatus (SCUBA) and emergency escape breathing apparatus.

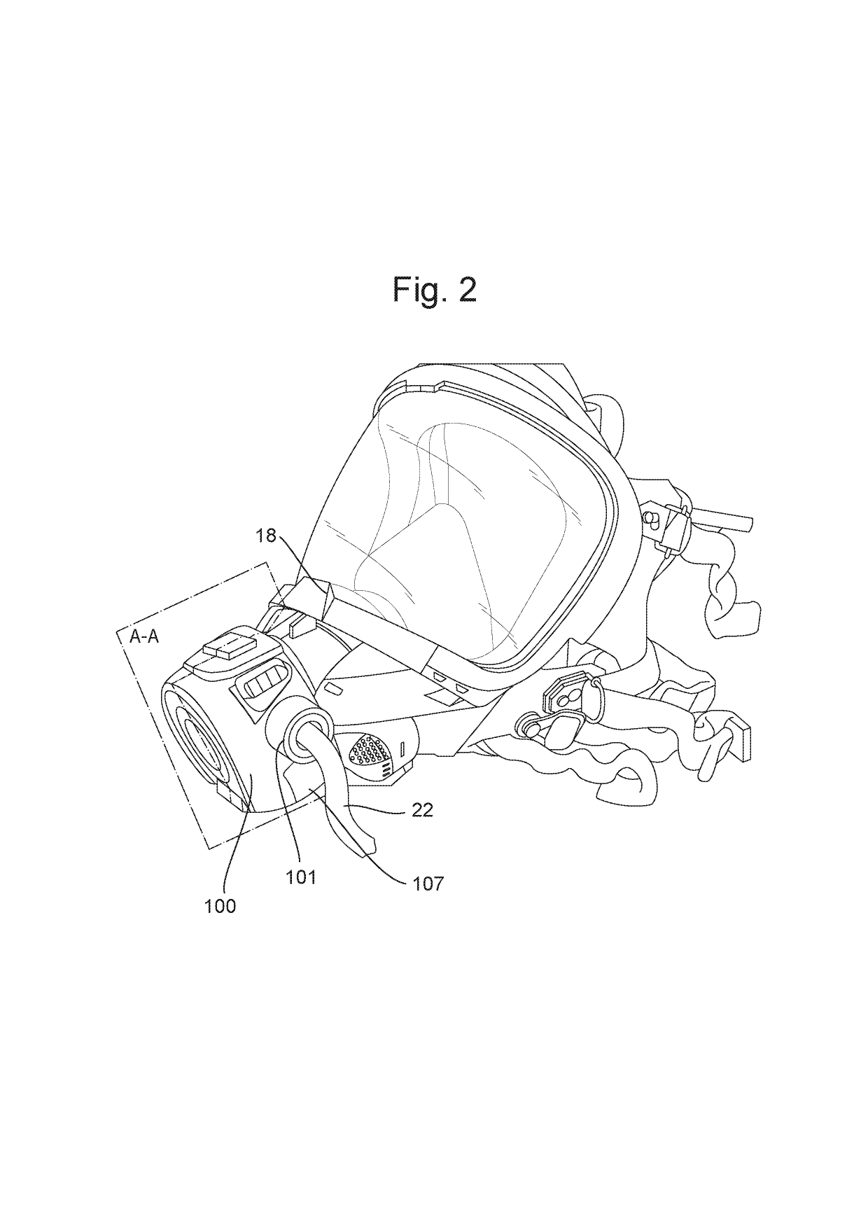

FIG. 2 schematically shows a face mask 18 attached to the regulator 100. As shown in more detail in FIG. 2, a hose 22 of the pneumatics system 20 is connected to an inlet 101 of the regulator 100 to provide breathing gas from the cylinder 16. The pneumatics system 20 comprises a first-stage pressure reducer 21 which reduces the pressure of the breathing air from the cylinder which may be stored at several hundred bar, to an intermediate pressure for provision to the regulator 100 via the hose 22. The intermediate pressure may be too high for the breathing gas to be provided directly to the user to breathe. The regulator 100 may further comprise a second-stage pressure reducer which further reduces the pressure of the breathing gas to a suitable pressure for delivery to the user to breathe. In other arrangements, more than two or fewer than two pressure reducers may be provided.

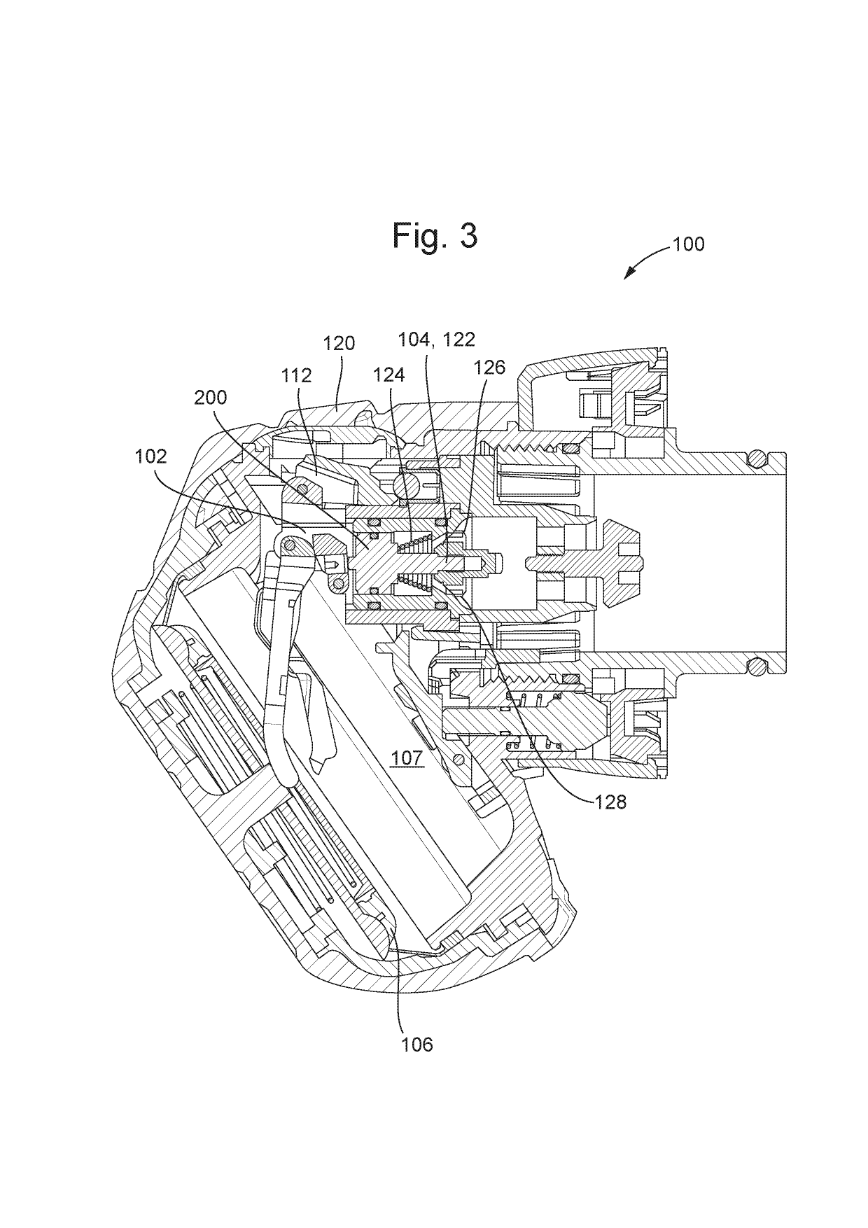

FIG. 3 schematically shows the regulator 100 in more detail. FIG. 3 shows a cross-sectional view of the regulator 100 on the plane A-A shown in the FIG. 2.

As shown in FIG. 3, the regulator 100 comprises a valve assembly 200 for regulating a flow of breathing gas. The valve assembly 200 comprises a regulator valve apparatus 102 for regulating a flow of breathing gas. The regulator valve apparatus 102 comprises a valve 104 that is actuatable between a closed position in which no flow is permitted and an open position in which flow is permitted. The valve 104 comprises a plunger 122, a spring 124, and a seal 126. When in the closed configuration, the seal 126 contacts a seal seat 128, thereby substantially preventing the breathing gas from flowing through the valve 104. When in an open configuration, the seal 126 is lifted from the seal seat 128 and thereby permits breathing gas to flow through the valve 104.

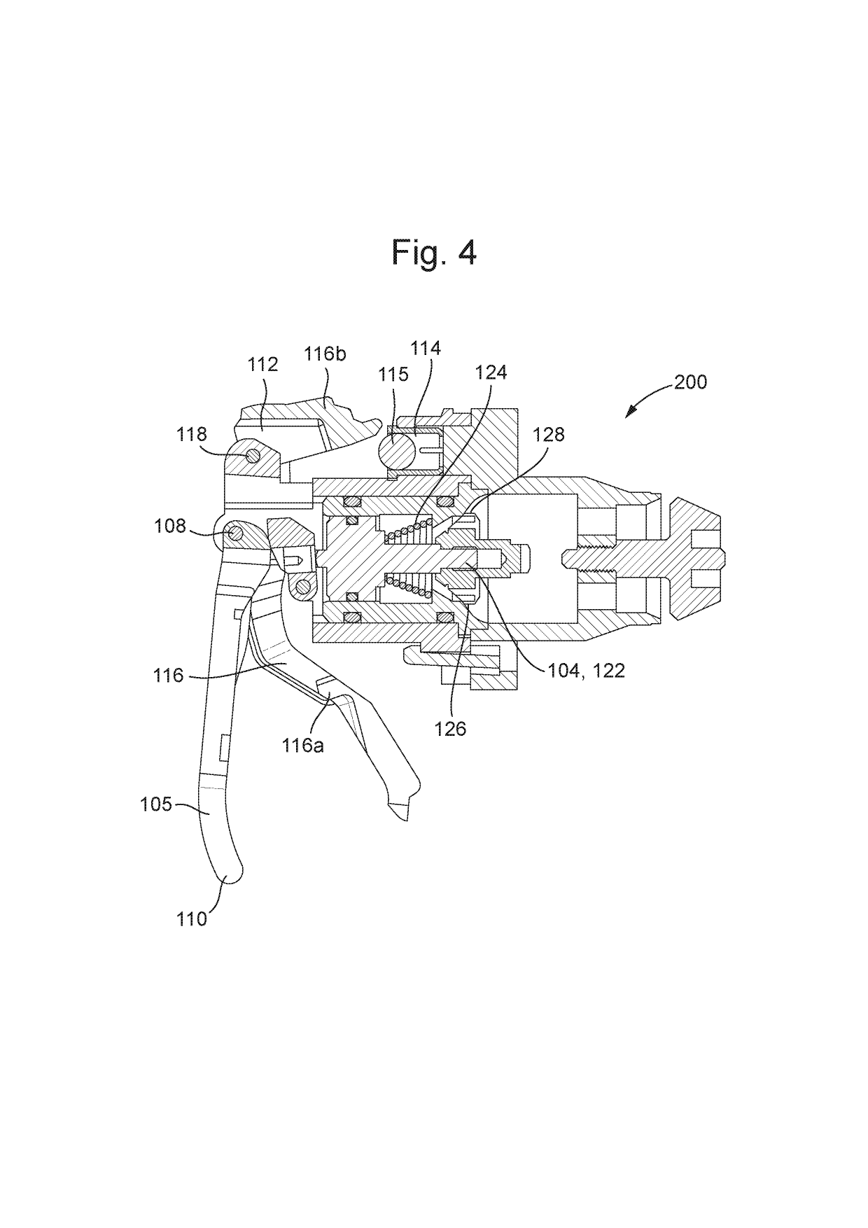

Turning to FIG. 4, the valve assembly 200 is shown in more detail. The valve 104 of the regulator valve apparatus 102 is actuated by a flow regulation lever 105. The flow regulation lever 105 is pivotable about a flow regulation lever pivot 108. The flow regulation lever 105 is mechanically linked to the seal 126 such that the further the flow regulation lever 105 rotates in an anticlockwise direction (relative to the figure), the further the seal 126 will be lifted away from the seal seat 128, increasing the rate of flow of breathing gas.

The regulator valve apparatus 102 further comprises a diaphragm 106 (shown in FIG. 3). The diaphragm 106 is configured to move or deform when there is a difference in pressure between an internal chamber 107 of the regulator 100 and the ambient pressure. The flow regulation lever 105, which comprises a flow regulation lever foot 110, is configured to contact the diaphragm 106 and be rotated as a result of movement of the diaphragm 106. It should be understood that the flow regulation lever 105 therefore forms part of a linkage configured to transmit movement of the diaphragm 106 to actuate the valve 104.

Starting from a state where the valve 104 is in the closed configuration and there is no breathing gas flowing, the user can inhale causing a drop in pressure in the regulator chamber 107 compared to the ambient pressure. The pressure differential causes the diaphragm 106 to move inwards. As the diaphragm 106 moves inwards, the flow regulation lever foot 110 is contacted by the diaphragm 106, causing the flow regulation lever 105 to rotate anticlockwise. The resulting anticlockwise movement is translated to the plunger 122, lifting the seal 126 off the seal seat 128. As a result, breathing gas can begin to flow. In many examples, this process will occur rapidly so as not to deprive the user of breathing gas as they inhale. In some configurations, the regulator valve apparatus 102 may be balanced such that, in a neutral position with no pressure differential across the diaphragm 106, the seal 126 is slightly separated from the seal seat 128 (i.e., a nearly-closed configuration) to provide a small constant flow of breathing gas to maintain positive pressure in the face mask 18, thereby preventing ambient gas ingress.

Once the user stops inhaling, there is generally a pause before they begin to exhale. During this pause, breathing gas continues to flow through the valve 104. The flowing breathing gas gradually increases the pressure inside the regulator chamber 107. The pressure further increases once the user begins to exhale. The pressure continues to increase until such point where the pressure in the regulator chamber 107 exceeds the ambient pressure, causing the diaphragm 106 to move outwards. As the diaphragm 106 moves outwards, the flow regulation lever foot 110 and thus the flow regulation lever 105 are no longer being held in place. Resultingly, the spring 124 inside the valve 104 overcomes the forces of the incoming supply of breathing gas, moving the seal 126 back onto, or close to, the seal seat 128. The valve 104 is now returned to the closed or nearly-closed configuration, where the cycle can repeat.

At certain points during use of the breathing apparatus 10, the user may wish to cease the flow of breathing gas, for example, when the user disconnects the regulator 100 from the face mask 18, or if the regulator 100 requires a manual reset.

In this example, the regulator 100 is provided with a lockout mechanism 112. The lockout mechanism 112 is configurable in: i) a lockout configuration in which the regulator valve apparatus 102 is secured in a closed position, and ii) a release configuration in which the regulator valve apparatus 102 is freely moveable. In this example, the lockout mechanism 112 is formed as part of the regulator valve apparatus 102.

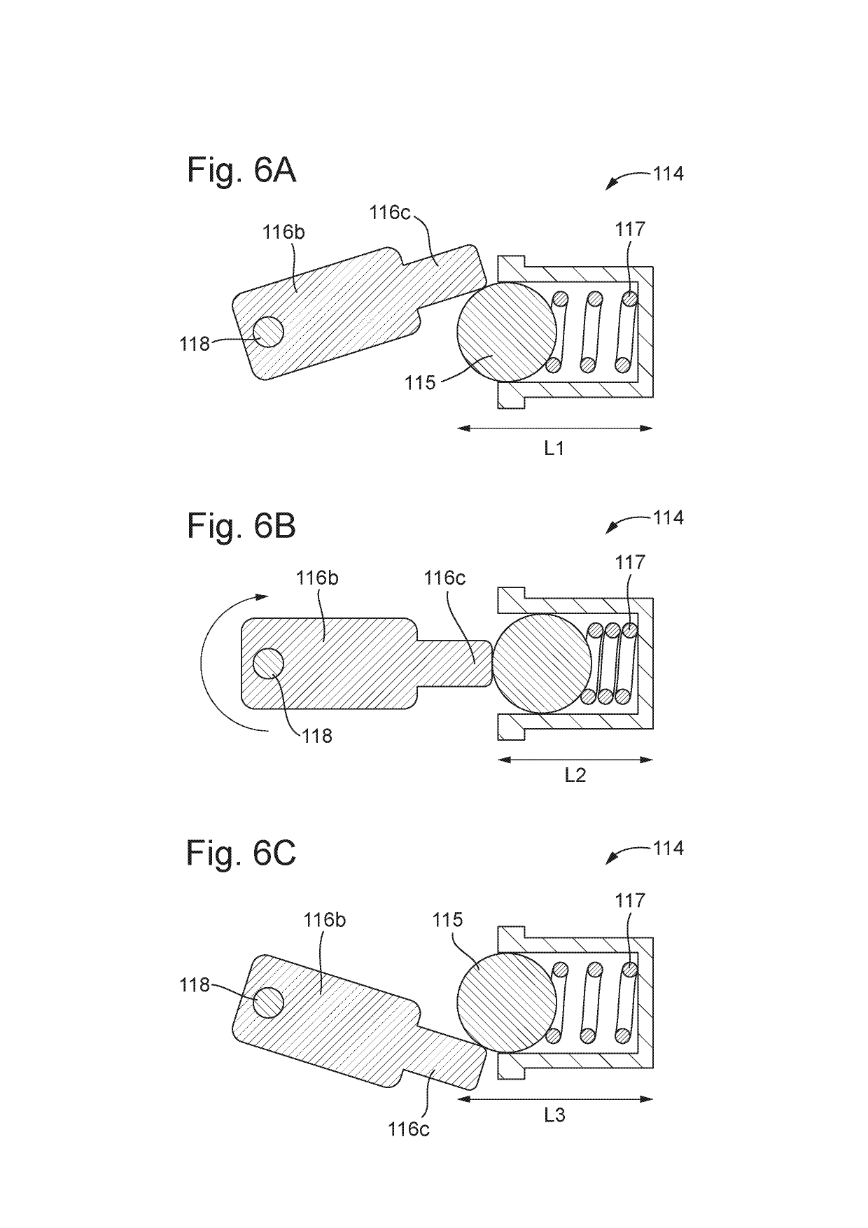

The lockout mechanism comprises a spring plunger 114. In the embodiment shown, the spring plunger 114 comprises a moveable element 115 (e.g., a ball bearing) which is urged towards an opening of the body of the spring plunger 114 by a biasing element 117 (see FIGS. 6A-6C). The biasing element 117 in this example is a helical spring. It will be appreciated that other forms of axially depressible biasing apparatus could be used, such as a hydraulic or gas spring or an element formed from resiliently deformable material. The moveable element 115 of the spring plunger 114 partially extends from the opening of the body when the spring plunger 114 is unloaded (i.e., not loaded).

It will be appreciated that the moveable element 115 of the spring plunger 114 is held captive within the body of the spring plunger 114, such that the moveable element 115 may translate within the body without escaping. The biasing element 117 is held within the body between the moveable element 115 and the body.

The strength of the biasing element 117 may be selected to ensure that a force of at least 5 N is required to sufficiently depress the spring plunger 114. In some embodiments, the force required may be between 5 N and 20 N. In some embodiments, the force required may between 9 N and 20 N.

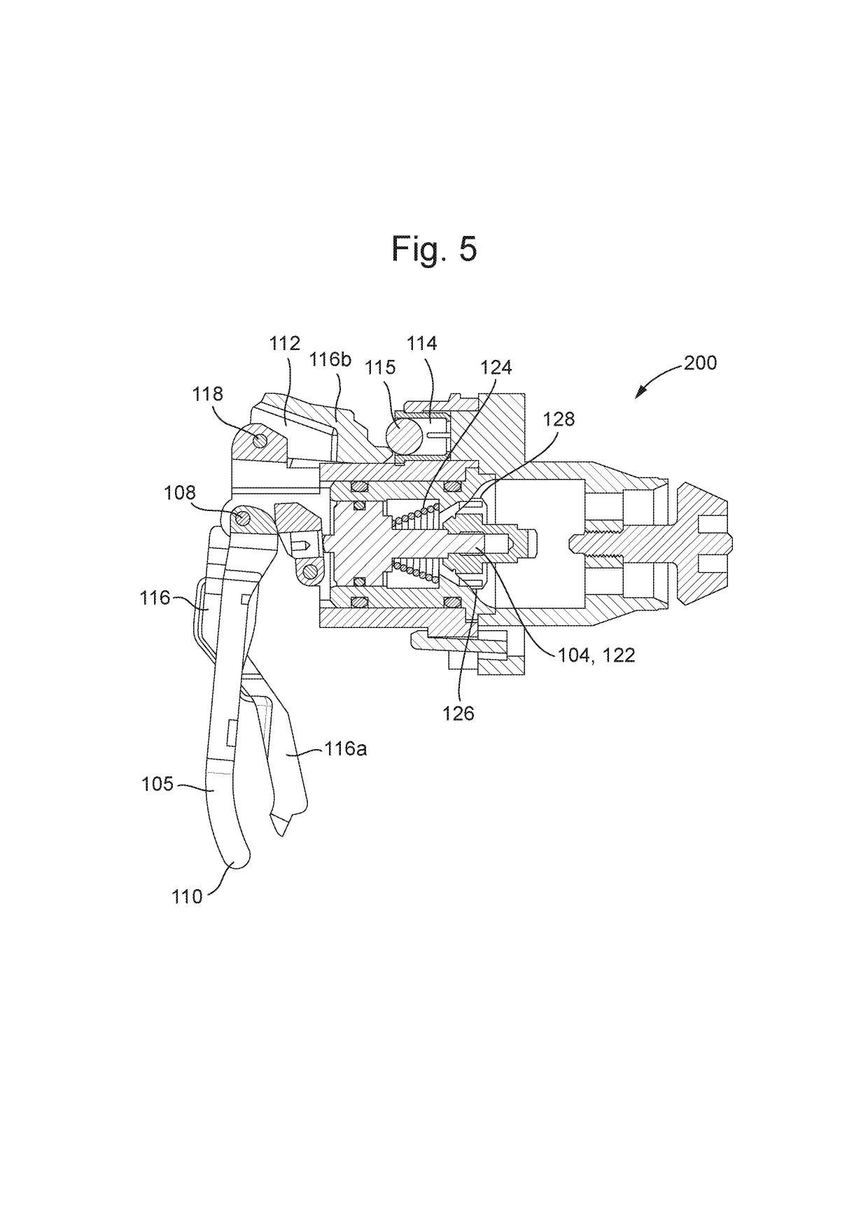

FIG. 4 shows the valve assembly 200 with the lockout mechanism 112 in the release configuration, while FIG. 5 shows the valve assembly 200 with the lockout mechanism 112 in the lockout configuration.

Referring to FIGS. 4 and 5 together, it will be appreciated that the spring plunger 114 is configured to provide a biasing force to assist in securing the lockout mechanism 112 in either of its release and lockout configurations. In order to further illustrate the function of the lockout mechanism 112, a schematic representation of the spring plunger 114 and retention lever 116 in isolation is shown in FIGS. 6A, 6B and 6C, in the release configuration, an intermediate position, and the lockout configuration, respectively.

As shown in FIGS. 4 and 6A, which represent the release configuration of the lockout mechanism 112, the moveable element 115 of the spring plunger 114 is in a resting position, not depressed relative to the opening of the spring plunger 114. Thus, the spring plunger 114 is at its maximum length, L1.

Similarly, FIGS. 5 and 6C show the lockout configuration of the lockout mechanism 112, where the moveable element 115 is also in a resting position, not depressed relative to the opening of the spring plunger 114. Thus, the spring plunger 114 is at its maximum length, L3. In this case L1 and L3 are equal in length.

As shown in FIG. 6B, during movement between the release configuration and the lockout configuration, the spring plunger 114 is configured to be axially compressed. That is to say, during such movement the moveable element 115 is axially depressed into the body of the spring plunger 114. Thus, during such movement the length of the spring plunger 114 is reduced to L2, where L2 is less than L1. It will be appreciated that the difference between L1 and L2 is equal to the depression distance of the moveable element 115 into the body of the spring plunger 114.

Of course, it will be understood, particularly when observing FIGS. 6A, 6B, and 6C, that the spring plunger 114 is axially depressed during movement of the lockout mechanism between the release configuration and the lockout configuration.

It will also be appreciated that in order to depress the spring plunger 114 during movement of the lockout mechanism between the lockout and release configurations, a force must be applied to the spring plunger 114.

In order to apply such a force to the spring plunger 114 to move the lockout mechanism 112 (and thus the spring plunger 114) between its release and lockout configurations, the spring plunger 114 is operatively coupled to a pivotable retention lever 116 (shown in FIGS. 4 and 5). The retention lever 116 is pivotable about a pivot axis 118, formed by a pivot pin. The pivot pin and thus the pivot axis 118 is perpendicular to the axial direction of the spring plunger 114. In some embodiments, including the embodiment shown, the pivot axis 118 is intersecting with the depression axis of the moveable element 115.

The retention lever 116 comprises a first lever arm 116a, which extends at a first angular position, and a second lever arm 116b, which extends at a second angular position. The first lever arm 116a is a retaining lever arm 116a, which engages the flow regulation lever 105 in the lockout configuration in order to secure the flow regulation lever 105 and thus the diaphragm 106 in a lockout configuration in which the valve 104 is closed. The second lever arm 116b is an actuation lever arm 116b, which operatively connects to the spring plunger 114. As shown in FIGS. 6A-6C, a distal tip 116c of the second lever arm 116b is responsible for engaging the spring plunger 114 via the moveable element 115.

In addition, as shown in FIG. 3, the actuation lever arm 116b is configured to be actuated by an activating button 120 on the exterior of the regulator 100, in order that the user can apply a pivoting force to the actuation lever arm 116b to pivot the retention lever 116 about the pivot axis 118.

During use of the breathing apparatus 10, the lockout mechanism 112 will be in the release position, as shown in FIGS. 4 and 6A. As described above, in this position, the spring plunger 114 is in its resting, non-depressed position, and has an effective axial length L1. The retention lever 116 is in a first angular position. In order to move the spring plunger 114 towards its notional depressed position, as shown in FIG. 6B, the distal tip 116c, must move arcuately (as shown by the arrow), which will cause an axial depression of the moveable element 115. Arcuate movement of the distal tip 116c causes a lateral force to be applied to the moveable element 115 on its top side (with reference to FIG. 6A). This lateral force is translated by the convex surface of the moveable element 115 into a force parallel to the depression axis of the spring plunger 114 – thus causing the moveable element 115 to depress into the body of the spring plunger 114. The biasing element 117 of the spring plunger 114 opposes this movement, and so opposes the axial depression of the moveable element 115 into the body of the spring plunger 114.

Absent any external force upon the lockout mechanism 112 (via the retention lever 116), the retention lever 116 will be retained in position (and prevented from pivoting) by the protruding part of the moveable element 115. A stop element may be provided to prevent over-rotation of the retention lever 116 in the anti-clockwise direction.

When it is desired to activate the lockout mechanism 112 (i.e., move the lockout mechanism 112 to the lockout configuration), a force is applied to the actuation lever arm 116b via the activating button 120 by the user. This force pivots the retention lever 116 in the clockwise direction as shown. The force is translated (by the convex shape of the moveable element 115) to a parallel force acting on the moveable element 115 and pushes against the opposing force applied by the biasing element 117. As the retention lever 116 pivots, the depression of the spring plunger 114 and the axial compression of the biasing element 117 increases until the axial compression of the spring plunger 114 reaches a maximum, as shown in FIG. 6B.

In FIG. 6B, the spring plunger 114 is axially depressed to its maximum extent and has an effective axial length L2, which is less than L1. This maximum depression distance is sufficient to permit the retention lever 116 to rotate past the spring plunger 114.

In the position shown in FIG. 6B, the spring plunger 114 is at an unstable ‘centre’. Due to the instability of this state, the retention lever 116 will not remain in this position. The combination of the momentum of the actuating lever arm 116b and the biasing element 117 of the spring plunger 114 applying a force will urge the actuating lever arm 116b away from this centre position in either the clockwise or anti-clockwise directions, as illustrated by the arrow in FIG. 6B.

In this example, if the force applied to the actuation lever arm 116b continues (i.e., by the user continuing to push the button 120), then the retention lever 116 will continue to pivot clockwise, and the spring plunger 114 will then assist in urging the retention lever 116 in the clockwise direction, as it releases the stored energy from the axial compression of the biasing element 117 during the first phase of the movement.

The retention lever 116 will thus continue to rotate clockwise (even in the absence of external force from the user to the position illustrated in FIGS. 5 and 6C, i.e., the lockout configuration. The spring plunger 114 is once again extended to its maximum position, and will now retain the retention lever 116 in this position, corresponding to a second angular position. The spring plunger 114 now has an effective axial length L3 which, in this example is equal to L1 and greater than L2. In other examples, it may be less than or greater than L1 and greater than L2. Pivoting in the anti-clockwise direction back towards the release configuration will be opposed by the spring plunger 114, as it requires the spring plunger 114 to be axially depressed once again. A further stop element may be provided to prevent over-rotation of the retention lever 116 in the clockwise direction.

In the embodiment shown, the moveable element 115 is a ball bearing, but any other moveable element with a substantially convex or sloped surface may also be applicable to the present disclosure. The moveable element 115 and the distal tip 116c of the retention lever 116 be formed of materials which enable the distal tip 116c to slide over the moveable element 115 as shown. In particular, the coefficient of friction between the two components may be low enough as to permit the distal tip 116c to slide over the moveable element 115.

The moveable element 115 may be formed of a metal or a metal alloy such as steel. The moveable element 115 may be formed of a polymeric material such as polytetrafluoroethylene (PTFE). The moveable element 115 may be formed of a ceramic material.

Overall, it should be appreciated that during a first portion of the movement between the release and lockout configurations, the spring plunger 114 resists movement and, once over the centre (i.e., the most axially depressed position), the spring plunger 114 assists movement into the other configuration. The spring plunger 114 therefore naturally retains the retention lever 116 (and therefore the lockout mechanism 112 as a whole) in both of the release and lockout configurations.

Some embodiments may provide that different applied forces are required to move between the positions. In particular, the spring plunger 114 and/or the actuating lever arm 116b may be shaped and/or biased such that more applied force is required to move from the release configuration to the lockout configuration than from the lockout configuration to the release configuration.

When moving from the release configuration to the lockout configuration, a user may apply the actuation force directly or indirectly, for example using the button 120. However, when moving from the lockout configuration to the release configuration, a ‘first breath’ activation may be required. In this example, the regulator valve apparatus 102, and in particular the diaphragm 106 and linkage comprising flow regulation lever 105, are configured to apply sufficient force to the lockout mechanism 112 to move the lockout mechanism 112 from the lockout configuration to the release configuration, by pivoting the retention lever 116 and thereby depressing the spring plunger 114 to its maximally depressed position (FIG. 6A) on application of a first-breath pressure differential to the regulator valve apparatus 102.

In some embodiments, in order to provide additional security in the lockout configuration, the valve assembly may further comprise a detent mechanism configured to assist in securing the lockout mechanism in the lockout configuration. The detent mechanism may comprise a retaining feature formed on the retention lever which engages a complementary retaining feature of the regulator, to thereby assist in retaining the lockout mechanism 112 in the lockout configuration. In some embodiments, the complementary feature may be a pivot pin of the flow regulation lever of the regulator valve apparatus. In other examples, other forms of detent mechanism may be provided to assist the spring plunger in retaining the lockout mechanism in the lockout configuration.

The valve assemblies of the present disclosure may provide an improved mechanism for disabling the flow of breathing gas through the regulator. The use of the mechanisms disclosed herein may provide improved tactile feedback to the user of the breathing apparatus while also providing a robust yet sensitive lockout function. The mechanism may provide improved safety as a user may engage the lockout mechanism more reliably and have more confidence in the lockout, particularly when wearing other personal protective equipment such as gloves, masks, and helmets, or in loud, emergency environments when visual and audible feedback may be less reliable or absent. Furthermore, the mechanisms described herein may provide a more secure lockout mechanism, with improved securing forces. Yet further, the mechanisms described herein may be simpler, more reliable, have a longer working life, and may require fewer bespoke parts.

It should be appreciated that the exemplary arrangement disclosed is one of many possible configurations for disabling the supply of breathing gas. Where alternative valve and regulator arrangements are used, it should be understood that the principles of the present disclosure could be applied and adapted to provide disablement of breathing gas flow.

1. A valve assembly for a lung demand regulator of a breathing apparatus comprising:
a regulator valve apparatus for regulating a flow of breathing gas, the regulator valve apparatus being actuatable between a closed position in which no flow is permitted and an open position in which flow is permitted; and
a lockout mechanism configurable in:
a lockout configuration in which the regulator valve apparatus is secured in the closed position; and
a release configuration in which the regulator valve apparatus is freely moveable,
wherein the lockout mechanism comprises a spring plunger,
wherein a moveable element of the spring plunger is configured to axially extend from a body of the spring plunger in the lockout configuration and in the release configuration, so as to retain the lockout mechanism in either of the lockout configuration and the release configuration, and
wherein the moveable element of the spring plunger is configured to be depressed by a portion of the lockout mechanism during movement of the lockout mechanism between the release configuration and the lockout configuration, so as to resist movement of the lockout mechanism between the release and lockout configurations.

2. The valve assembly of claim 1, wherein the moveable element is biased to at least partially extend from an opening in the body of the spring plunger by a biasing element.

3. The valve assembly of claim 2, wherein the biasing element is a helical spring.

4. The valve assembly of claim 2, wherein the biasing element is a volume of compressed gas.

5. The valve assembly of claim 1, wherein the lockout mechanism comprises a pivotable lever in operative connection with the spring plunger such that angular movement of the pivotable lever depresses the spring plunger.

6. The valve assembly as claimed in claim 5, wherein the pivotable lever is configured in a first angular position in the lockout configuration and is configured in a second angular position in the release configuration, and wherein the pivotable lever is configured to pivot between the first angular position and the second angular position.

7. The valve assembly of claim 5, wherein the pivotable lever is pivotable about a pivot axis, the pivot axis being perpendicular to an axial direction of movement of the moveable element of the spring plunger.

8. The valve assembly of claim 7, wherein the pivot axis and the axial direction are intersecting.

9. The valve assembly of claim 5, wherein the pivotable lever comprises a first lever arm configured to operatively connect with the spring plunger, and a second lever arm configured to engage the regulator valve apparatus in the lockout configuration.

10. The valve assembly of claim 9, wherein the first lever arm comprises a distal tip configured to engage the moveable element of the spring plunger.

11. The valve assembly of claim 10, wherein the moveable element is formed of any of a metal, a polymer, and/or a ceramic material.

12. The valve assembly of claim 1, wherein the moveable element of the spring plunger comprises a convex surface such that a lateral force applied to the moveable element by the lockout mechanism causes the moveable element to depress into the body of the spring plunger.

13. The valve assembly of claim 1, wherein the lockout mechanism is configured to be moved from the release configuration to the lockout configuration by application of force on an activation component of the lockout mechanism by a user.

14. The valve assembly of claim 13, wherein the activation component is a lever or button which is pressable by a user.

15. The valve assembly of claim 1, wherein the spring plunger is a ball plunger, a pin plunger, a hydraulic plunger, or a pneumatic plunger.

16. The valve assembly of claim 1, wherein a force required to depress the moveable element such that lockout mechanism can move between the lockout configuration and the release configuration is at least 5 Newtons.

17. A lung demand regulator comprising a valve assembly, the valve assembly comprising:
a regulator valve apparatus for regulating a flow of breathing gas, the regulator valve apparatus being actuatable between a closed position in which no flow is permitted and an open position in which flow is permitted; and
a lockout mechanism configurable in:
a lockout configuration in which the regulator valve apparatus is secured in the closed position; and
a release configuration in which the regulator valve apparatus is freely moveable,
wherein the lockout mechanism comprises a spring plunger,
wherein a moveable element of the spring plunger is configured to axially extend from a body of the spring plunger in the lockout configuration and in the release configuration, so as to retain the lockout mechanism in either of the lockout configuration and the release configuration, and
wherein the moveable element of the spring plunger is configured to be depressed by a portion of the lockout mechanism during movement of the lockout mechanism between the release configuration and the lockout configuration, so as to resist movement of the lockout mechanism between the release and lockout configurations.

18. The lung demand regulator of claim 17, wherein the lockout mechanism is configured to be moved from the lockout configuration to the release configuration by a diaphragm of the lung demand regulator pushing against the lockout mechanism when a pressure differential across a first side of the diaphragm and a second side of the diaphragm exceeds a threshold.

19. A breathing apparatus comprising a lung demand regulator,, wherein the lung demand regulator comprises a valve assembly, the valve assembly comprising:
a regulator valve apparatus for regulating a flow of breathing gas, the regulator valve apparatus being actuatable between a closed position in which no flow is permitted and an open position in which flow is permitted; and
a lockout mechanism configurable in:
a lockout configuration in which the regulator valve apparatus is secured in the closed position; and
a release configuration in which the regulator valve apparatus is freely moveable,
wherein the lockout mechanism comprises a spring plunger,
wherein a moveable element of the spring plunger is configured to axially extend from a body of the spring plunger in the lockout configuration and in the release configuration, so as to retain the lockout mechanism in either of the lockout configuration and the release configuration, and
wherein the moveable element of the spring plunger is configured to be depressed by a portion of the lockout mechanism during movement of the lockout mechanism between the release configuration and the lockout configuration, so as to resist movement of the lockout mechanism between the release and lockout configurations.

20. The breathing apparatus of claim 19, further comprising a face mask for connection to the lung demand regulator.
